(19) United States
(12) Patent Application Publication
(10) Pub. No.: US 2023/0060776 A1
(43) Pub. Date: Mar. 2, 2023

(54) DECISION CONSISTENCY PROFILER FOR AN AUTONOMOUS DRIVING VEHICLE

(71) Applicant: Baidu USA LLC, Sunnyvale, CA (US)

(72) Inventors: Shu JIANG, Sunnyvale, CA (US); Weiman LIN, Sunnyvale, CA (US); Yu CAO, Sunnyvale, CA (US); Yu WANG, Sunnyvale, CA (US); Qi LUO, Sunnyvale, CA (US); Jiangtao HU, San Jose, CA (US); Jinghao MIAO, San Mateo, CA (US)

(21) Appl. No.: 17/446,648

(22) Filed: Sep. 1, 2021

(51) Int. Cl. B60W 60/00; B60W 30/095; B60W 30/18; G01C 21/34

(52) U.S. Cl. CPC B60W 60/0015; B60W 60/0013; B60W 30/095; B60W 30/18009; G01C 21/3461

(57) ABSTRACT

Embodiments of the invention are intended to evaluate the performance of a planning module of the ADV in terms of decision consistency in addition to other metrics, such as comfort, latency, controllability, and safety. In one embodiment, an exemplary method includes receiving, at an autonomous driving simulation platform, a record file recorded by the ADV that was automatically driving on a road segment; simulating operations of a dynamic model of the ADV in the autonomous driving simulation platform during one or more driving scenarios on the road segment based on the record file. The method further includes performing a comparison between each planned trajectory generated by a planning module of the dynamic model after an initial period of time with each trajectory stored in a buffer; and modifying a performance score generated by a planning performance profiler in the autonomous driving simulation platform based on a result of the comparison.

### TECHNICAL FIELD

Embodiments of the present disclosure relate generally to operating autonomous vehicles. More particularly, embodiments of the disclosure relate to evaluating decision consistency of an autonomous driving vehicle in generating planned trajectories in a multimodal situation.

### BACKGROUND

An autonomous driving vehicle (ADV), when driving in an automatic mode, can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

An ADV typically generates a planned trajectory at a regular interval to guide the ADV to move forward. Sometimes, the ADV may encounter a multimodal situation where there are multiple equally good solutions. For example, when encountering an obstacle, the ADV may generate a planned path to pass the obstacle from the right, from the left, or stay behind the obstacle. These decisions may be equally good in terms of some conventional measurements of the planning functions, such as comfort, safety, controllability, and efficiency.

However, if the ADV cannot consistently stick to one decision, and instead keeps switching among the several equally good strategies, there could be serious consequences, for example, the ADV could collide with an obstacle. Thus, it is important for an ADV to be consistent in planning its trajectories in a multimodal situation.

### BRIEF DESCRIPTION OF THE DRAWINGS

Embodiments of the disclosure are illustrated by way of example and not limitation in the figures of the accompanying drawings in which like references indicate similar elements.

FIG. 1 illustrates an example of an autonomous driving simulation platform for some embodiments of the invention.

FIG. 2 illustrates a process of evaluating planning functions of an ADV according to one embodiment.

FIG. 3 further illustrates the process of evaluating planning functions of an ADV according to one embodiment.

FIG. 4 is a flow diagram illustrating a process of evaluating decision consistency in trajectory planning of an ADV according to another embodiment.

FIG. 5 is a block diagram illustrating an autonomous driving vehicle according to one embodiment of the invention.

FIG. 6 illustrates a vehicle control system according to one embodiment of the invention.

FIG. 7 is a block diagram illustrating an example of an autonomous driving system used with an autonomous driving vehicle according to one embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to various embodiments, described herein are systems, methods, and media for evaluating the performance of a planning module of an ADV in terms of consistency in trajectory planning in a multimodal situation, where each current planned trajectory after an initial period of time with each historical planned trajectory stored in a buffer, and modify a performance score of the planning module based on a result of the comparison Decision consistency in a multimodal situation is critical to the safety of an ADV. For example, when facing two equally good decisions in terms of terms of comfort, latency, controllability, and safety, such as changing lane to pass an obstacle and nudging an obstacle, the ADV could collide with the obstacle if it keeps changing its decisions, instead of sticking to one of the decisions. Embodiments of the invention are intended to evaluate the performance of a planning module of the ADV in terms of decision consistency in addition to other metrics, such as comfort, latency, controllability, and safety.

In one embodiment, an exemplary method includes receiving, at an autonomous driving simulation platform, a record file recorded by the ADV that was automatically driving on a road segment; simulating operations of a dynamic model of the ADV in the autonomous driving simulation platform during one or more driving scenarios on the road segment based on the record file. The method further includes performing a comparison between each planned trajectory generated by a planning module of the dynamic model after an initial period of time with each trajectory stored in a buffer; and modifying a performance score generated by a planning performance profiler in the autonomous driving simulation platform based on a result of the comparison.

In one embodiment, the performance score is kept unchanged when the result of the comparison indicates a same decision, and penalized by subtracting a number of points from the performance score when the result of the comparison indicates a different decision.

In one embodiment, the buffer has a predetermined size, and stores planned trajectories generated by the dynamic model of the ADV during an initial period of time. Thereafter, each planned trajectory can be compared with each historical planned trajectory stored in the buffer. Once being compared with each historical planned trajectory in the buffer, the current planned trajectory can be inserted into the buffer from one end, and in the meanwhile, another planned trajectory can be removed from the buffer from the other end.

In one embodiment, when each pair of planned trajectories are compared in terms of their shapes, and speeds of the dynamic model at each of a number points on each of the planned trajectories.

The embodiments described above are not exhaustive of all aspects of the present invention. It is contemplated that the invention includes all embodiments that can be practiced from all suitable combinations of the various embodiments summarized above, and also those disclosed below.

### Performance Evaluation

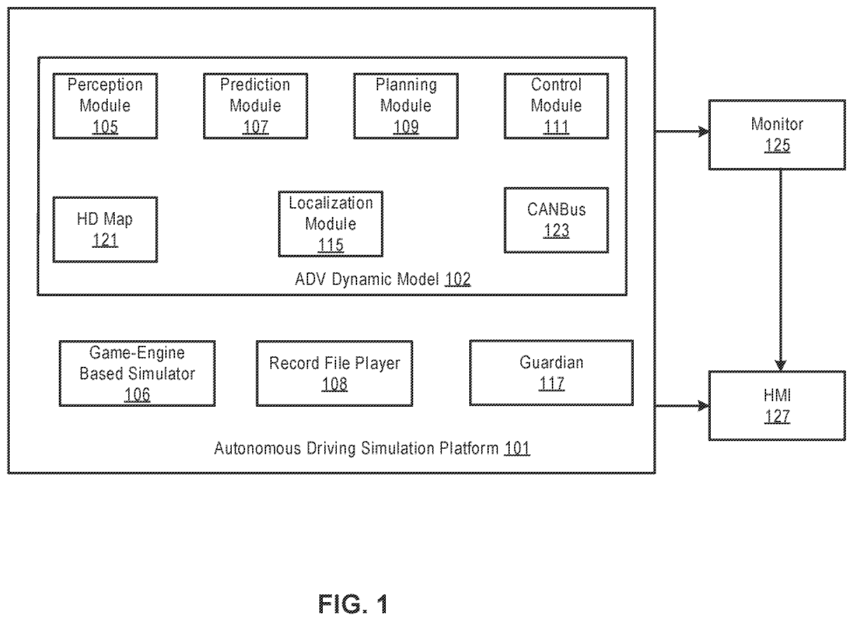

FIG. 1 illustrates an example of an autonomous driving simulation platform for some embodiments of the invention.

The safety and reliability of an ADV are guaranteed by massive functional and performance tests, which are expensive and time consuming if these tests were conducted using physical vehicles on roads. A simulation platform 101 shown in this figure can be used to perform these tasks less costly and more efficiently.

In one embodiment, the example simulation platform 101 includes a dynamic model 102 of an ADV, a game-engine based simulator 105, and a record file player 108. The game-engine based simulator 105 can provide a 3D virtual world where sensors can perceive and provide precise ground truth data for every piece of an environment. The record file player 108 can replay record files recorded in the real world for use in testing the functions and performance of various modules of the dynamic model 102.

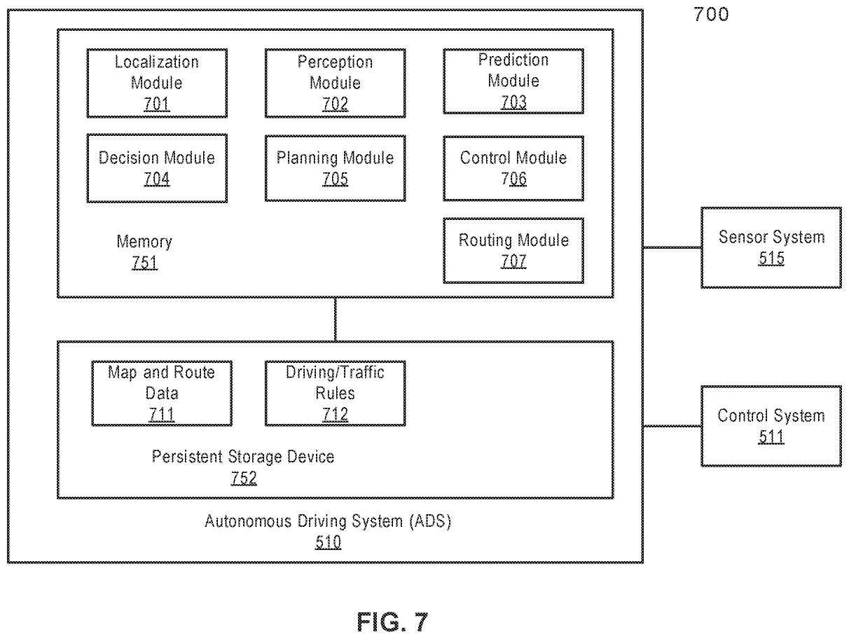

In one embodiment, the ADV dynamic model 102 can be a virtual vehicle that includes a number of core software modules, including a perception module 405, a prediction module 107, a planning module 109, a control module 111, a localization module 115, a CANBus module 123. These functions of these modules will be described in detail in FIG. 7.

As further shown, the simulation platform 101 can include a guardian module 117, which is a safety module that performs the function of an action center and intervenes when a monitor 125 detects a failure. When all modules work as expected, the guardian module 117 allows the flow of control to work normally. When a crash in one of the modules is detected by the monitor 125, the guardian module 127 can prevent control signals from reaching the CANBus 123 and can bring the ADV dynamic model 102 to a stop.

The simulation platform 101 can include a human machine interface (HMI) 127, which is a module for viewing the status of the dynamic model 102, and controlling the dynamic model 102 in real time.

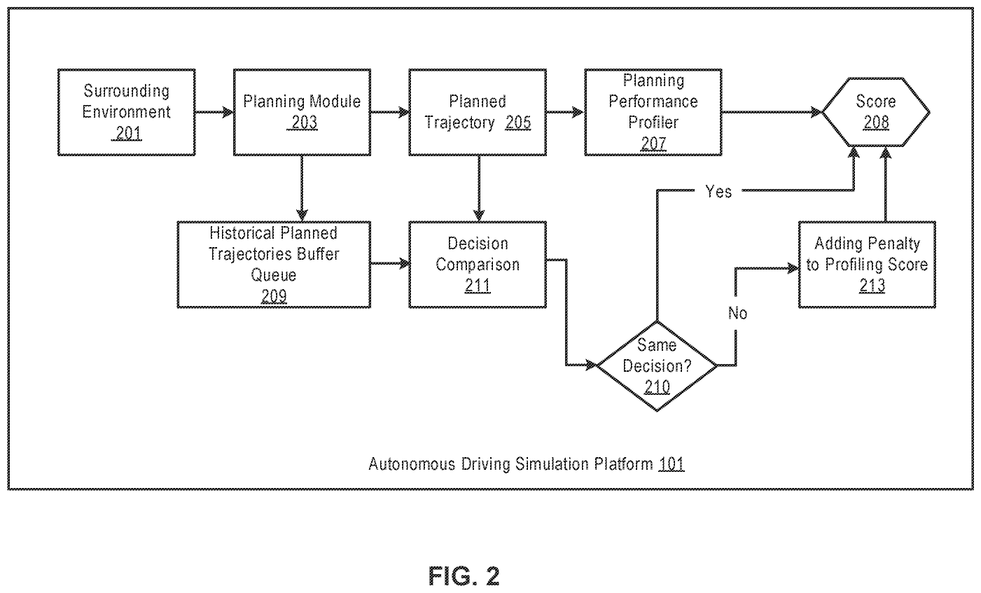

FIG. 2 illustrates a process of evaluating planning functions of an ADV according to one embodiment.

As shown in FIG. 2, the evaluation process can be performed within the simulation platform 101 with a surrounding environment 201 injected through a record file uploaded into the simulation platform 101.

In one embodiment, a record file can include outputs of the autonomous driving modules for each frame during road tests, and can be replayed to recreate a virtual environment for simulating operations of a dynamic model of an ADV. The virtual environment can include information for static scenes and dynamic scenes. The information for the static scenes can include a variety of stationary traffic signs, such as stop lines, traffic signs, etc. The information for the dynamic scenes can include dynamic traffic flows around the ADV, such as vehicles, pedestrians, traffic lights and so on.

In one embodiment, during the simulation, a planning module 203 of the dynamic model can generate a planned trajectory 205 per frame (e.g., per 100 ms), which can be fed into a planning performance profiler 207. The planning performance profiler 207 can evaluate the planned trajectory 205 in terms of latency, controllability, safety, and comfort.

In one embodiment, in the area of latency, the features can include a chosen trajectory latency, a zig-zag trajectory latency, and a stage completed time. In the area of controllability, the features can include non-gear-switch trajectory length ratio, an initial heading difference ratio, a normalized curvature ration, a curvature changing rate ratio, an acceleration ratio, a deceleration ratio, and a longitudinal jerk ratio. In the area of comfort, the features can include a longitudinal jerk ratio, lateral jerk ratio, a longitudinal acceleration ratio, and a lateral acceleration ratio, a longitudinal deceleration ratio, a lateral deceleration ration, a distance to boundaries ratio, a distance to obstacle ratio, and a time to collision ratio. In the area of safety, the features can include a distance to obstacle ratios, and a time to collision ratio. The above features are provided as the purpose of illustration. Different features or additional features can be extracted and calculated for each of the above four areas.

Based on the above features, the planning performance profiler 207 can generate a performance score for the planning module per frame, and generates a performance score 208 for all the frames. The performance score 208 can be a mathematic means or a weighted mean for all the frames up to a particular point of time. If a weighted mean is used, each frame can be assigned a weight that indicates the complexity of a surrounding environment of the dynamic model at that particular moment.

For example, if there is heavy traffic surrounding the dynamic model of the ADV for a particular frame, the performance score for that frame can be given a heavier weight.

In one embodiment, the planned trajectories generated during an initial period of time (e.g., 2 minutes) of the simulation can be stored in a buffer queue 209. With the planning cycle (e.g., 100 ms) of the dynamic model of the ADV given, the total number of planned trajectories generated by the dynamic model can be calculated during the initial period of time. The size of the buffer queue can be determined based on the total number of planned trajectories generated during the initial period of time. The buffer queue needs to be large enough to store all the planned trajectories during the initial period of time.

After the initial period of time, simultaneously with generating a performance score for a frame, the planned trajectory for that frame can be compared with each historical planned trajectory stored in the buffer queue 209 by a decision comparison module 211.

In one embodiment, the decision comparison module 211 can be a software module, or a trained neural network model. When implemented as a neural network model, the decision comparison module 211 can take two semantic maps as input, and output a score that indicates a similarity between the two semantic maps. The semantic maps can encode the pair of planned trajectories to be compared. Thus, a difference between the two semantic maps indicates a difference between the pair of planned trajectory being compared.

In one embodiment, each semantic map can be an image that encodes a planned trajectory and a speed of the vehicle at each of a number of points on the planned trajectory. Different hues of blue or another color can be used to represent different speeds on the semantic map.

The decision comparison module 211 as a neural network model, can compare the pair of semantic maps to determine whether the two semantic are similar or not. Based on the comparison, the decision comparison module 211 can output an indicator indicating whether the pair of planned trajectories represent a same decision or two different decisions.

For example, during the simulation, the dynamic model of the ADV is travelling in a lane with another vehicle in the same lane and blocking the dynamic model. If during a particular frame, the planning module 203 of the dynamic model generates a planned trajectory, whose shape indicates that the dynamic model intends to pass the blocking vehicle from the left, and during the immediate next frame, the planning module 203 generates a planned trajectory, whose shapes indicates that that the dynamic intends to pass the blocking vehicle from the right, then the decision comparison module 211 can decide that the two planned trajectories are different because their shapes are substantially different.

As another example, in the above scenario, even if the planned trajectories are substantially the same, but if the differences between speeds at corresponding points on the two planned trajectories exceeds a predetermined threshold, the decision comparison module 211 would still determine that the two planned trajectories represents two different decisions.

Thus, when a current planned trajectory is compared with each historical planned trajectory, a comparison result can be outputted by the decision comparison module 211. When the comparison result indicates a same decision 210, the decision comparison module 211 would not modify the performance score 208; otherwise, the decision comparison module 211 would penalize 213 the performance score 208 by subtracting a number of points from the performance score 208. After the current planned trajectory is compared with each historical planned trajectory in the buffer queue 209, the current planned trajectory is saved to the buffer queue 209.

As such, when the simulation is completed, the performance score 208 can be used to indicate a level of decision consistency of the dynamic models in a multimodal situation in the virtual environment.

For example, the performance score 208, coupled with a proper threshold derived from empirical data, can indicate whether the dynamic model of the ADV has been consistent in its decision in passing a blocking vehicle from a particular side. If the level of consistency is low, which could indicate the dynamic model intends to pass a blocking vehicle from the left at one frame, and intends to pass the blocking vehicle from the right at another frame, a collision with the blocking vehicle may occur.

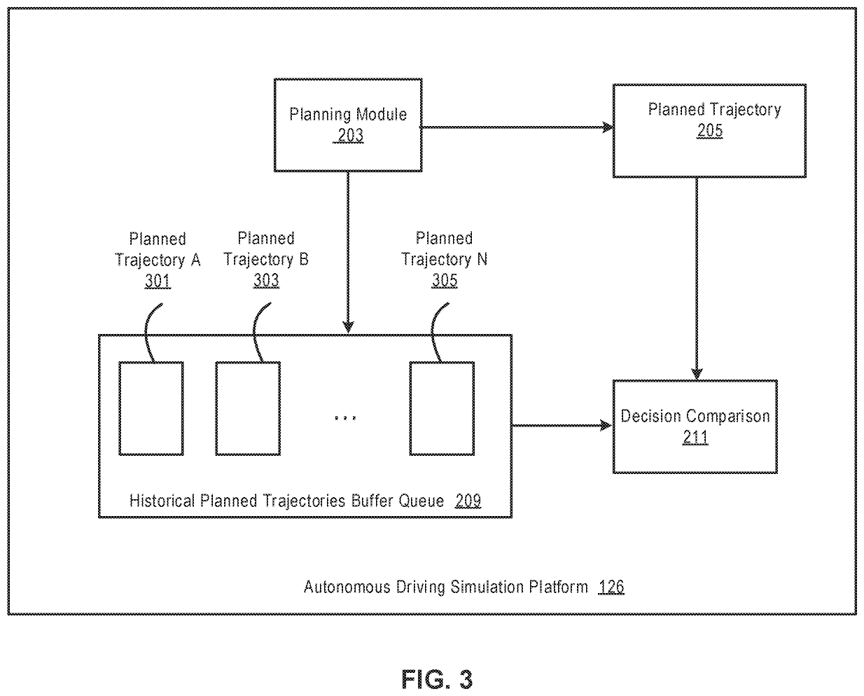

FIG. 3 further illustrates the process of evaluating planning functions of an ADV according to one embodiment. More particularly, FIG. 3 illustrates the buffer queue 209 used to store historical planned trajectories.

As shown in FIG. 3, the historical planned trajectories buffer queue 209 can include multiple planned trajectories, for example, a planned trajectory A 301, a planned trajectory B 303, and a planned trajectory N. The number of the planned trajectories stored in the buffer queue 209 can be determined based on the duration of the test run. In one embodiment, the buffer queue 209 needs to be large enough to hold all planned trajectories generated during the test run, which can be the initial period of time (e.g., the first 2 minutes) after the simulation starts.

The current planned trajectory 205 can be compared with each planned trajectory stored in the buffer queue 209, and then stored in the buffer queue 209. The current planned trajectory 205 can be pushed to the buffer queue 209 from one end, and at the same time, an oldest planned trajectory in the buffer queue 209 can be popped from the buffer queue 209. Thus, the adding and removing of planned trajectories are performed according to a first in, first out (FIFO) policy.

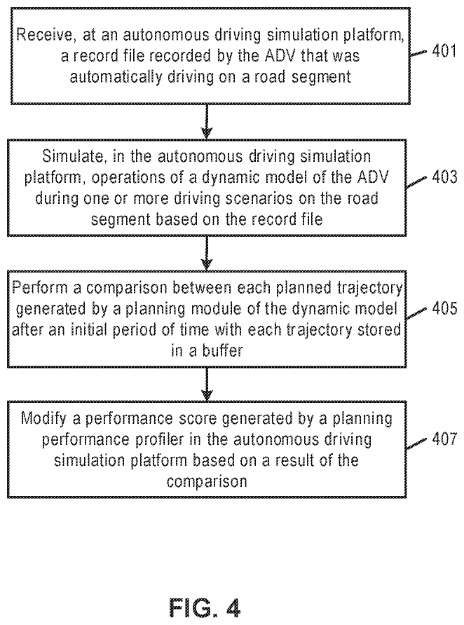

FIG. 4 is a flow diagram illustrating a process of evaluating decision consistency in trajectory planning of an ADV according to another embodiment. The process may be performed by a processing logic which may include software, hardware, or a combination thereof. For example, the process may be performed by the various software components described in FIG. 2.

As shown in FIG. 4, in operation 401, the processing logic at the autonomous driving simulation platform receives a record file recorded by the ADV that was automatically driving on a road segment. The simulation platform may have a standard interface that enables an uploading of record files in an appropriate format. The record file can include static scenes and dynamic scenes of a road segment on which the record file was recorded by a vehicle travelling thereon. The record file can also include real-time output messages of each autonomous driving module of the recording vehicle. The output messages can include real-time planned trajectories per frame (e.g., planning cycle) while the autonomous vehicle was travelling on the road segment. The record can be replayed by the simulation platform, or used otherwise to create a virtual road segment for simulating operations of a dynamic model of an ADV. The dynamic model can be a virtual ADV, and can include one or more autonomous driving modules to be tested and evaluated.

In operation 403, the processing logic operates to simulating operations of the dynamic model of the ADV during one or more driving scenarios on the virtual road segment. Each of the one or more driving scenarios can be a driving scene derived from the record file. Examples of the driving scenes include an intersection with traffic lights, a scene with pedestrians, and a scene with blocking vehicles. The dynamic model includes a planning module whose performance is to be evaluated. The planning module generates a planned trajectory per frame during the simulation while travelling through the one or more driving scenario on the virtual road segment.

In operation 405, the processing logic performs a comparison between each planned trajectory generated by a planning module of the dynamic model after an initial period of time with each trajectory stored in a buffer. The comparison does not start until after the dynamic model has run for a period of time, during which the processing logic populates the buffer with planned trajectories. The buffer can be a buffer queue, whose size is set based on the length of the initial period of time. After the initial period of time (also referred to a test run), each planned trajectory generated by the dynamic model can be compared with each historical planned trajectory stored in the buffer. The comparison can be performed by a trained neural network that takes a pair of semantic maps as input. The semantic maps encode the trajectories to be compared. The neural network outputs a decision result based on the pair of semantic maps. Each semantic maps can encode the shape of a planned trajectory and speeds of a vehicle at each of a number equally-distanced points on the trajectory. The speeds can be represented by different hues of a color. Simultaneously with the comparisons between the current trajectory and historical trajectories in the buffer, the processing logic can evaluate the performance of the planning module from the start of the simulation in terms of comfort, latency, controllability, and safety; and output a performance score.

In operation 407, the processing logic can modify that performance score based on a result of the comparison per frame. Thus, after the initial period of time, each comparison between a current planned trajectory and a historical planned frame may potentially cause a change in the performance score. If a result of a comparison indicates a same decision, the performance score will not be changed; otherwise, one or more points can be subtracted from the performance score.

Thus, the end result of the above simulation process can generate a modified performance score that reflects decision consistency of the planned module in a multi-modal situation. The modified score reflects safety, controllability, latency, and comfort as well as decision consistency of the planning module.

### Automatic Driving Vehicle

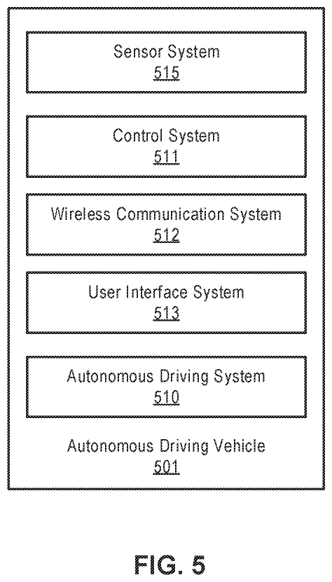

FIG. 5 is a block diagram illustrating an autonomous driving vehicle according to one embodiment of the invention. Referring to FIG. 5, autonomous driving vehicle 501 may be communicatively coupled to one or more servers over a network, which may be any type of networks such as a local area network (LAN), a wide area network (WAN) such as the Internet, a cellular network, a satellite network, or a combination thereof, wired or wireless. The server(s) may be any kind of servers or a cluster of servers, such as Web or cloud servers, application servers, backend servers, or a combination thereof. A server may be a data analytics server, a content server, a traffic information server, a map and point of interest (MPOI) server, or a location server, etc.

An autonomous driving vehicle refers to a vehicle that can be configured to in an autonomous mode in which the vehicle navigates through an environment with little or no input from a driver. Such an autonomous driving vehicle can include a sensor system having one or more sensors that are configured to detect information about the environment in which the vehicle operates. The vehicle and its associated controller(s) use the detected information to navigate through the environment. Autonomous driving vehicle 501 can operate in a manual mode, a full autonomous mode, or a partial autonomous mode.

In one embodiment, autonomous driving vehicle 501 includes, but is not limited to, autonomous driving system (ADS) 510, vehicle control system 511, wireless communication system 512, user interface system 513, and sensor system 515. Autonomous driving vehicle 501 may further include certain common components included in ordinary vehicles, such as, an engine, wheels, steering wheel, transmission, etc., which may be controlled by vehicle control system 511 and/or ADS 510 using a variety of communication signals and/or commands, such as, for example, acceleration signals or commands, deceleration signals or commands, steering signals or commands, braking signals or commands, etc.

Components 510-515 may be communicatively coupled to each other via an interconnect, a bus, a network, or a combination thereof. For example, components 510-515 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

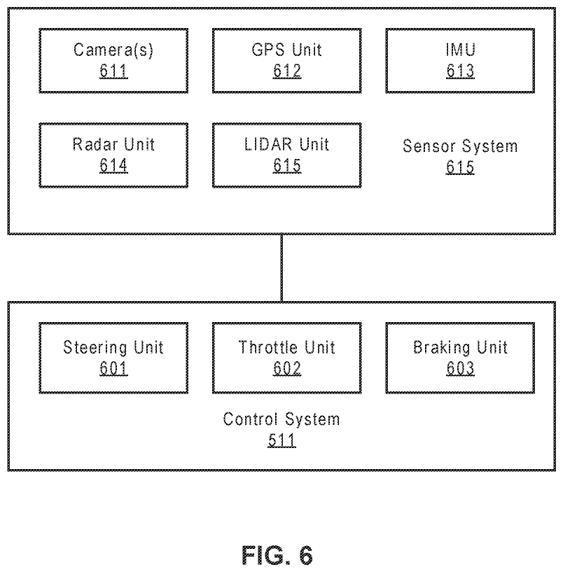

Referring now to FIG. 6, in one embodiment, sensor system 515 includes, but it is not limited to, one or more cameras 611, global positioning system (GPS) unit 612, inertial measurement unit (IMU) 613, radar unit 614, and a light detection and range (LIDAR) unit 615. GPS system 612 may include a transceiver operable to provide information regarding the position of the autonomous driving vehicle. IMU unit 613 may sense position and orientation changes of the autonomous driving vehicle based on inertial acceleration. Radar unit 614 may represent a system that utilizes radio signals to sense objects within the local environment of the autonomous driving vehicle. In some embodiments, in addition to sensing objects, radar unit 614 may additionally sense the speed and/or heading of the objects. LIDAR unit 615 may sense objects in the environment in which the autonomous driving vehicle is located using lasers. LIDAR unit 615 could include one or more laser sources, a laser scanner, and one or more detectors, among other system components. Cameras 611 may include one or more devices to capture images of the environment surrounding the autonomous driving vehicle. Cameras 611 may be still cameras and/or video cameras. A camera may be mechanically movable, for example, by mounting the camera on a rotating and/or tilting a platform.

Sensor system 515 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the autonomous driving vehicle. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 511 includes, but is not limited to, steering unit 601, throttle unit 602 (also referred to as an acceleration unit), and braking unit 603. Steering unit 601 is to adjust the direction or heading of the vehicle. Throttle unit 602 is to control the speed of the motor or engine that in turn controls the speed and acceleration of the vehicle. Braking unit 603 is to decelerate the vehicle by providing friction to slow the wheels or tires of the vehicle. Note that the components as shown in FIG. 6 may be implemented in hardware, software, or a combination thereof.

Referring back to FIG. 5, wireless communication system 512 is to allow communication between autonomous driving vehicle 501 and external systems, such as devices, sensors, other vehicles, etc. For example, wireless communication system 512 can wirelessly communicate with one or more devices directly or via a communication network. Wireless communication system 512 can use any cellular communication network or a wireless local area network (WLAN), e.g., using WiFi to communicate with another component or system. Wireless communication system 512 could communicate directly with a device (e.g., a mobile device of a passenger, a display device, a speaker within vehicle 501), for example, using an infrared link, Bluetooth, etc. User interface system 513 may be part of peripheral devices implemented within vehicle 501 including, for example, a keyboard, a touch screen display device, a microphone, and a speaker, etc.

Some or all of the functions of autonomous driving vehicle 501 may be controlled or managed by ADS 510, especially when operating in an autonomous driving mode. ADS 510 includes the necessary hardware (e.g., processor(s), memory, storage) and software (e.g., operating system, planning and routing programs) to receive information from sensor system 515, control system 511, wireless communication system 512, and/or user interface system 513, process the received information, plan a route or path from a starting point to a destination point, and then drive vehicle 501 based on the planning and control information. Alternatively, ADS 510 may be integrated with vehicle control system 511.

For example, a user as a passenger may specify a starting location and a destination of a trip, for example, via a user interface. ADS 510 obtains the trip related data. For example, ADS 510 may obtain location and route data from an MPOI server. The location server provides location services and the MPOI server provides map services and the POIs of certain locations. Alternatively, such location and MPOI information may be cached locally in a persistent storage device of ADS 510.

While autonomous driving vehicle 501 is moving along the route, ADS 510 may also obtain real-time traffic information from a traffic information system or server (TIS). Note that the servers may be operated by a third party entity. Alternatively, the functionalities of the servers may be integrated with ADS 510. Based on the real-time traffic information, MPOI information, and location information, as well as real-time local environment data detected or sensed by sensor system 515 (e.g., obstacles, objects, nearby vehicles), ADS 510 can plan an optimal route and drive vehicle 501, for example, via control system 511, according to the planned route to reach the specified destination safely and efficiently.

FIG. 7 is a block diagram illustrating an example of an autonomous driving system used with an autonomous driving vehicle according to one embodiment. System 700 may be implemented as a part of autonomous driving vehicle 501 of FIG. 5 including, but is not limited to, ADS 510, control system 511, and sensor system 515. Referring to FIG. 7, ADS 510 includes, but is not limited to, localization module 701, perception module 702, prediction module 703, decision module 704, planning module 705, control module 706, routing module 707.

Some or all of modules 701-706 may be implemented in software, hardware, or a combination thereof. For example, these modules may be installed in persistent storage device 752, loaded into memory 751, and executed by one or more processors (not shown). Note that some or all of these modules may be communicatively coupled to or integrated with some or all modules of vehicle control system 511 of FIG. 6. Some of modules 601-606 may be integrated together as an integrated module.

Localization module 701 determines a current location of autonomous driving vehicle 501 (e.g., leveraging GPS unit 612) and manages any data related to a trip or route of a user. Localization module 701 (also referred to as a map and route module) manages any data related to a trip or route of a user. A user may log in and specify a starting location and a destination of a trip, for example, via a user interface. Localization module 701 communicates with other components of autonomous driving vehicle 501, such as map and route data 711, to obtain the trip related data. For example, localization module 701 may obtain location and route data from a location server and a map and POI (MPOI) server. A location server provides location services and an MPOI server provides map services and the POIs of certain locations, which may be cached as part of map and route data 711. While autonomous driving vehicle 300 is moving along the route, localization module 701 may also obtain real-time traffic information from a traffic information system or server.

Based on the sensor data provided by sensor system 515 and localization information obtained by localization module 701, a perception of the surrounding environment is determined by perception module 702. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 702 may include a computer vision system or functionalities of a computer vision system to process and analyze images captured by one or more cameras in order to identify objects and/or features in the environment of autonomous driving vehicle. The objects can include traffic signals, road way boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 702 can also detect objects based on other sensors data provided by other sensors such as a radar and/or LIDAR.

For each of the objects, prediction module 703 predicts what the object will behave under the circumstances. The prediction is performed based on the perception data perceiving the driving environment at the point in time in view of a set of map/rout information 711 and traffic rules 712. For example, if the object is a vehicle at an opposing direction and the current driving environment includes an intersection, prediction module 803 will predict whether the vehicle will likely move straight forward or make a turn. If the perception data indicates that the intersection has no traffic light, prediction module 803 may predict that the vehicle may have to fully stop prior to enter the intersection. If the perception data indicates that the vehicle is currently at a left-turn only lane or a right-turn only lane, prediction module 703 may predict that the vehicle will more likely make a left turn or right turn respectively.

For each of the objects, decision module 704 makes a decision regarding how to handle the object. For example, for a particular object (e.g., another vehicle in a crossing route) as well as its metadata describing the object (e.g., a speed, direction, turning angle), decision module 704 decides how to encounter the object (e.g., overtake, yield, stop, pass). Decision module 704 may make such decisions according to a set of rules such as traffic rules or driving rules 712, which may be stored in persistent storage device 752.

Routing module 707 is configured to provide one or more routes or paths from a starting point to a destination point. For a given trip from a start location to a destination location, for example, received from a user, routing module 707 obtains route and map information 711 and determines all possible routes or paths from the starting location to reach the destination location. Routing module 707 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 704 and/or planning module 705. Decision module 704 and/or planning module 705 examine all of the possible routes to select and modify one of the most optimal routes in view of other data provided by other modules such as traffic conditions from localization module 701, driving environment perceived by perception module 702, and traffic condition predicted by prediction module 703. The actual path or route for controlling the ADV may be close to or different from the reference line provided by routing module 707 dependent upon the specific driving environment at the point in time.

Based on a decision for each of the objects perceived, planning module 705 plans a path or route for the autonomous driving vehicle, as well as driving parameters (e.g., distance, speed, and/or turning angle), using a reference line provided by routing module 707 as a basis. That is, for a given object, decision module 704 decides what to do with the object, while planning module 705 determines how to do it. For example, for a given object, decision module 704 may decide to pass the object, while planning module 705 may determine whether to pass on the left side or right side of the object. Planning and control data is generated by planning module 705 including information describing how vehicle 501 would move in a next moving cycle (e.g., next route/path segment). For example, the planning and control data may instruct vehicle 512 to move 10 meters at a speed of 30 miles per hour (mph), then change to a right lane at the speed of 25 mph.

Based on the planning and control data, control module 706 controls and drives the autonomous driving vehicle, by sending proper commands or signals to vehicle control system 511, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 705 plans a next route segment or path segment, for example, including a target position and the time required for the ADV to reach the target position. Alternatively, planning module 705 may further specify the specific speed, direction, and/or steering angle, etc. In one embodiment, planning module 705 plans a route segment or path segment for the next predetermined period of time such as 5 seconds. For each planning cycle, planning module 805 plans a target position for the current cycle (e.g., next 5 seconds) based on a target position planned in a previous cycle. Control module 706 then generates one or more control commands (e.g., throttle, brake, steering control commands) based on the planning and control data of the current cycle.

Note that decision module 704 and planning module 705 may be integrated as an integrated module. Decision module 704/planning module 705 may include a navigation system or functionalities of a navigation system to determine a driving path for the autonomous driving vehicle. For example, the navigation system may determine a series of speeds and directional headings to affect movement of the autonomous driving vehicle along a path that substantially avoids perceived obstacles while generally advancing the autonomous driving vehicle along a roadway-based path leading to an ultimate destination. The destination may be set according to user inputs via user interface system 513. The navigation system may update the driving path dynamically while the autonomous driving vehicle is in operation. The navigation system can incorporate data from a GPS system and one or more maps so as to determine the driving path for the autonomous driving vehicle.

According to one embodiment, a system architecture of an autonomous driving system as described above includes, but it is not limited to, an application layer, a planning and control (PNC) layer, a perception layer, a device driver layer, a firmware layer, and a hardware layer. The application layer may include user interface or configuration application that interacts with users or passengers of an autonomous driving vehicle, such as, for example, functionalities associated with user interface system 513. The PNC layer may include functionalities of at least planning module 705 and control module 706. The perception layer may include functionalities of at least perception module 702. In one embodiment, there is an additional layer including the functionalities of prediction module 703 and/or decision module 704. Alternatively, such functionalities may be included in the PNC layer and/or the perception layer. The firmware layer may represent at least the functionality of sensor system 515, which may be implemented in a form of a field programmable gate array (FPGA). The hardware layer may represent the hardware of the autonomous driving vehicle such as control system 511. The application layer, PNC layer, and perception layer can communicate with the firmware layer and hardware layer via the device driver layer.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method of evaluating planning functions of an autonomous driving vehicle (ADV), the method comprising:
receiving, at an autonomous driving simulation platform, a record file recorded by the ADV that was automatically driving on a road segment;
simulating, in the autonomous driving simulation platform, operations of a dynamic model of the ADV during one or more driving scenarios on the road segment based on the record file;
performing a comparison between each planned trajectory generated by a planning module of the dynamic model after an initial period of time with each trajectory stored in a buffer; and
modifying a performance score generated by a planning performance profiler in the autonomous driving simulation platform based on a result of the comparison.

2. The method of claim 1, wherein the modifying of the performance score includes keeping the performance score unchanged when the result of the comparison indicates a same decision, and subtracting a number of points from the performance score when the result of the comparison indicates a different decision.

3. The method of claim 2, wherein the buffer has a predetermined size, and stores planned trajectories generated by the dynamic model of the ADV during a period of time immediately preceding to a current planning cycle, the period of time equal to the initial period of time in length.

4. The method of claim 2, wherein the planned trajectories are stored in the buffer according to a first-in, and first-out (FIFO) policy.

5. The method of claim 2, wherein each of the same decision and the different decision is made based on shapes of the planned trajectories being compared, and speeds of the dynamic model at each of a number points on each of the planned trajectories being compared.

6. The method of claim 1, wherein the performance score generated by the planning performance profiler measures a performance of the planning module in terms of comfort, latency, controllability, and safety.

7. The method of claim 1, wherein the modified performance score measures a performance of the planning module in terms of comfort, latency, controllability, safety, and decision consistency.

8. A non-transitory machine-readable medium having instructions stored therein, which when executed by a processor, cause the processor to perform operations of evaluating planning functions of an autonomous driving vehicle (ADV), the operations comprising:
receiving, at an autonomous driving simulation platform, a record file recorded by the ADV that was automatically driving on a road segment;
simulating, in the autonomous driving simulation platform, operations of a dynamic model of the ADV during one or more driving scenarios on the road segment based on the record file;
performing a comparison between each planned trajectory generated by a planning module of the dynamic model after an initial period of time with each trajectory stored in a buffer; and
modifying a performance score generated by a planning performance profiler in the autonomous driving simulation platform based on a result of the comparison.

9. The non-transitory machine-readable medium 8, wherein the modifying of the performance score includes keeping the performance score unchanged when the result of the comparison indicates a same decision, and subtracting a number of points from the performance score when the result of the comparison indicates a different decision.

10. The non-transitory machine-readable medium 9, wherein the buffer has a predetermined size, and stores planned trajectories generated by the dynamic model of the ADV during a period of time immediately preceding to a current planning cycle, the period of time equal to the initial period of time in length.

11. The non-transitory machine-readable medium 9, wherein the planned trajectories are stored in the buffer according to a first-in, and first-out (FIFO) policy.

12. The non-transitory machine-readable medium 9, wherein each of the same decision and the different decision is made based on shapes of the planned trajectories being compared, and speeds of the dynamic model at each of a number points on each of the planned trajectories being compared.

13. The non-transitory machine-readable medium 8, wherein the performance score generated by the planning performance profiler measures a performance of the planning module in terms of comfort, latency, controllability, and safety.

14. The non-transitory machine-readable medium 8, wherein the modified performance score measures a performance of the planning module in terms of comfort, latency, controllability, safety, and decision consistency.

15. A data processing system, comprising:
a processor; and
a memory coupled to the processor to store instructions, which when executed by the processor, cause the processor to perform operations of evaluating planning functions of an autonomous driving vehicle (ADV), the operations comprising:
receiving, at an autonomous driving simulation platform, a record file recorded by the ADV that was automatically driving on a road segment,
simulating, in the autonomous driving simulation platform, operations of a dynamic model of the ADV during one or more driving scenarios on the road segment based on the record file,
performing a comparison between each planned trajectory generated by a planning module of the dynamic model after an initial period of time with each trajectory stored in a buffer, and
modifying a performance score generated by a planning performance profiler in the autonomous driving simulation platform based on a result of the comparison.

16. The data processing system of claim 15, wherein the modifying of the performance score includes keeping the performance score unchanged when the result of the comparison indicates a same decision, and subtracting a number of points from the performance score when the result of the comparison indicates a different decision.

17. The data processing system of claim 16, wherein the buffer has a predetermined size, and stores planned trajectories generated by the dynamic model of the ADV during a period of time immediately preceding to a current planning cycle, the period of time equal to the initial period of time in length.

18. The data processing system of claim 16, wherein the planned trajectories are stored in the buffer according to a first-in, and first-out (FIFO) policy.

19. The data processing system of claim 16, wherein each of the same decision and the different decision is made based on shapes of the planned trajectories being compared, and speeds of the dynamic model at each of a number points on each of the planned trajectories being compared.

20. The data processing system of claim 15, wherein the performance score generated by the planning performance profiler measures a performance of the planning module in terms of comfort, latency, controllability, and safety.
